(19) United States
(12) Patent Application Publication
(10) Pub. No.: US 2009/0289478 A1
(43) Pub. Date: Nov. 26, 2009

(54) CONVERTIBLE, MULTI-PURPOSE CHILDREN'S CHAIR

(76) Inventor: Robert Piserchio, Pueblo, CO (US)

Correspondence Address: BRENDA L. SPEER;BRENDA L SPEER, LLC, 2 NORTH CASCADE AVENUE, SUITE 1100, COLORADO SPRINGS, CO, 80903, US

(21) Appl. No.: 12/123,855

(22) Filed: May 20, 2008

(51) Int. Cl. A47D 1/06; A47D 11/00; B62B 7/12

(52) U.S. Cl. 297/118; 280/30

(57) ABSTRACT

A convertible, multi-purpose children's chair comprising a chair, further comprising a seat and a seat back; front legs inter-related with said seat, wherein said front legs comprise an articulable front leg portion and an unarticulable front leg portion, further wherein said articulable front leg portion and said unarticulable front leg portion are articulable in relation to each other; back legs which are inter-related to said seat, further wherein said back legs are articulably related with said seat back; a wheelbase comprising front wheels and back wheels, wherein said front wheels are inter-related with said front legs and said back wheels are inter-related with said seat and said back legs; and a tray which is inter-related with said seat back, wherein said tray is pivotably connected with said seat back, further wherein said tray further comprises a tray insert rotatable within said tray.

### BACKGROUND OF THE INVENTION

1. Field of the Invention

The present invention pertains to a convertible, multi-purpose children's chair comprising a unitary device which may be converted into various positions to function as a stroller, chair or high chair.

2. Description of Related Art Including Information Disclosed Under 37 CFR 1.97 and 37 CFR 1.98

Prior art devices are known which allow a device to be converted into various configurations for use as a child's stroller, high chair, rocking chair, car seat, bassinet and the like. Several of these prior art devices are disclosed herein.

Three US patents by Fleischer for Baby Holding Device, namely U.S. Pat. No. 3,961,803 issued Jun. 8, 1976, U.S. Pat. No. 3,967,833 issued Jul. 6, 1976, and U.S. Pat. No. 3,971,079 issued Jul. 27, 1976, disclose a portable baby holding device which may take the form of a combination baby carriage, stroller, infant seat, car seat, car bed, bassinet, high chair and the like and comprises a baby carrier means and baby shielding or protective means.

U.S. Pat. No. 4,019,751 issued Apr. 26, 1977, by Nakao for Multi-Purpose Infant's Wheeled Chair discloses a multipurpose infant's wheel chair having a rockable base with front and rear wheels which can be swung to engage the ground or to be positioned so that the rockable base engages the ground and the devise is usable for rocking or rolling.

U.S. Pat. No. 4,239,259 issued Dec. 16, 1980, by Martinez for Height Adjustable Infant Stroller-High Chair discloses a height adjustable infant stroller and high chair combination comprising a seat member, seat member supporting structure and seat member leveling structure; wherein the seat member is vertically positionable along the seat member supporting structure at selected elevations while maintaining the supporting portion of the of the seat member substantially parallel with the supporting surface of the device.

U.S. Pat. No. 4,762,331 issued Aug. 9, 1988, by Tucker et al. for Combination Automobile Seat and Stroller discloses a combination car seat and stroller having a plurality of wheels which are pivotable between a first, lowered position for use as a stroller and a second, raised position for use as a car seat.

U.S. Pat. No. 4,786,064 issued Nov. 22, 1988, by Baghdasarian for Convertible Infant Seat discloses an infant seat which converts from a car seat into a stroller; wherein the infant seat comprises a chair connected to a wheel frame on which the wheel set is mounted, and when the wheel frame is in a stowed condition, it supports the chair in a car seat configuration, and when the wheel frame is in an unstowed condition, it supports the chair in a stroller configuration.

U.S. Pat. No. 4,887,834 issued Dec. 19, 1989, by Cabagnero for Foldable Baby Stroller Chassis discloses a foldable baby stroller chassis which allows for a foldable baby stroller chassis which may be locked in a folded and unfolded position and which includes an armrest assembly.

U.S. Pat. No. 5,224,720 issued Jul. 6, 1993, by Chaw et al. for Stroller for a Baby discloses a multi-purposed stroller that includes a chair mounted upon a three-wheeled frame which has one front wheel and two rear wheels; wherein the chair can be removed from the frame for use as a chair; further wherein the front wheel of the frame can be removed and the stroller can be hitched to another device, such as a bicycle; and further wherein the stroller has a cover for shielding the baby from sunshine and rain.

U.S. Pat. No. 5,230,523 issued Jul. 27, 1993, by Wilhelm for Multi-Functional Child Carrier Device discloses a multi-functional child carrier device including a base having a detachable seat, the backrest portion detachably connectable to the base and slots formed within the both the backrest and the base to allow the unit to serve as a child safety seat or as an infant carrier seat utilizing only the backrest; wherein the device includes elevation supports secured and retractable within the base for supporting the base in an elevated position so that the device may function as a child's chair; and further wherein the wheels are attachable to the elevation supports so that the device may function as a stroller.

U.S. Pat. No. 5,265,931 issued Nov. 30, 1993, by Ryan for Detachable Child Seat and Supporting Frame discloses an infant/child seat and frame combination wherein the seat is mountable and de-mountable to and from the frame by a combination of seat back hooks and seat bottom positioning elements engageable with compatibly configured frame members on the frame; further wherein various frame configurations may be constructed to accept the seat, e.g., a car seat frame, a stroller frame, a high chair frame, or a wheelchair frame, so that the same seat may be moved from one frame to another to serve varying purposes.

U.S. Pat. No. 5,354,079 issued Oct. 11, 1994, by Hettenbach for Nestable Adjustable Stroller discloses a nestable adjustable stroller having a chassis with upper and lower crossbars and a seat having a series of ribs on the bottom and a hanger bracket mounted on the back; wherein in the seating position the back of the seat rests against the upper crossbar and the lower crossbar rests in a groove between a pair of ribs at the bottom of the seat; further wherein to prepare the stroller for storage, the seat is raised so that a crook in the hanger bracket rests on the upper crossbar.

U.S. Pat. No. 5,375,869 issued Dec. 27, 1994, by Hsiao for Structure for a Versatile Baby Stroller discloses a versatile baby stroller comprising a resting portion and a wheel-frame portion which provide the function of a baby crib, a stroller, a high chair for feeding and a bath pan can be placed on it for the convenience of bathing a baby; wherein the resting portion can be removed from the wheel-frame portion to allow for the various usage combinations.

U.S. Pat. No. 5,673,924 issued Oct. 7, 1997, by Demick et al. for Multi-Function Baby Support and Transportation Apparatus discloses a multi-function baby support and transportation apparatus which is convertible to be used in a car seat mode, a carrier mode, a stroller mode or a high chair mode; wherein a superstructure for supporting a child is vertically extensible from an undercarriage that provides a storage space and carries a retractable wheel assembly.

U.S. Pat. No. 5,829,826 issued Nov. 3, 1998, by Ziccardi for Convertible Childs Chair discloses a child's chair that can be converted from a stroller type chair to a high chair; wherein a wheelbase is pivotally interconnected to a handle; further wherein a seat can be positioned at a location intermediate to the wheel base for use as a stroller; further wherein the seat can be positioned at a location intermediate to the handle for use as a high chair.

U.S. Pat. No. 6,062,588 issued May 16, 2000, by Cheng for Folding Structure for a Collapsible Stroller discloses a folding, structure for a collapsible stroller that has a pair of pivotal connectors, a pushing handle, two front support rods, two rear support rods, a pair of connecting holder blocks, a chair back frame and two connecting rods; wherein the connecting holder blocks are provided with a press block to prevent unintended collapsing of the stroller.

U.S. Pat. No. 7,163,228 B2 issued Jan. 16, 2007, by Faber for Collapsible Stroller discloses a collapsible stroller having a collapsible chair having a seat portion, a back portion, and a pair of arms of foldable material such as textile cloth; wherein the stroller has a collapsible frame having folding legs, folding arm supports, and rear uprights supporting the seat portion, the back portion and the pair of arms; further wherein the legs form four chair leg bases having wheeled castors extending downward from each base; further wherein the chair collapses radially inward so as to form a generally cylindrical configuration for ease of transport.

Each of these prior art devices employs a different means by which the conversion of the device to another configuration is achieved. Among these are a collapsible frame and/or seat, a frame having a separate means to retract a wheelbase, a seat slidably mounted in relation to a frame, wheels which are removable from a frame, a chair which is separable from a frame, and the like.

In contrast to the prior art, the convertible, multi-purpose children's chair device of the present invention comprises a chair inter-related with a wheelbase, both of which are inter-related to an articulated frame; wherein the articulated frame allows for a one-operation repositioning of the wheelbase in pivotal relation to the frame to convert the device between a stroller and a high chair configurations.

### BRIEF SUMMARY OF THE INVENTION

A convertible, multi-purpose children's chair comprising a chair, further comprising a seat and a seat back; front legs inter-related with said seat, wherein said front legs comprise an articulable front leg portion and an unarticulable front leg portion, further wherein said articulable front leg portion and said unarticulable front leg portion are articulable in relation to each other; back legs which are inter-related to said seat, further wherein said back legs are articulably related with said seat back; a wheelbase comprising front wheels and back wheels, wherein said front wheels are inter-related with said front legs and said back wheels are inter-related with said seat and said back legs; and a tray which is inter-related with said seat back, wherein said tray is pivotably connected with said seat back, further wherein said tray further comprises a tray insert rotatable within said tray.

### BRIEF DESCRIPTION OF THE SEVERAL VIEWS OF THE DRAWING(S)

FIG. 1 is a side view of the convertible, multi-purpose children's chair device of the present invention in a high chair configuration.

FIG. 2 is a side view of the convertible, multi-purpose children's chair device of the present invention in a stroller configuration.

FIG. 3 is a top plan view of a tray of the convertible, multi-purpose children's chair device of the present invention.

### LIST OF REFERENCE NUMERALS

2 device
4 seat
6 seat back
8 tray
10 arm rest
12 front wheel(s)
14 back wheel(s)
15 unarticulable front leg portion
16 front leg(s)
17 articulable front leg portion
18 back leg(s)
20 side brace(s)
22 back leg brace and/or stroller handle
24 front wheel mount
26 back wheel mount
28 front leg articulation means
30 back leg articulation means
32 tray pivot means
34 tray release means
36 tray insert
38 tray insert rotation means
40 foot rest

### DETAILED DESCRIPTION OF THE INVENTION

The convertible, multi-purpose children's chair of the present invention comprises a unitary device which may be converted into various positions to function as a stroller, a chair or as a high chair. The device may be scaled in any appropriate dimensions such that it is suitable for use as a convertible, multi-purpose children's chair; wherein the device is scaled to accommodate a human child, or the device is scaled to accommodate a child's toy, such as a doll.

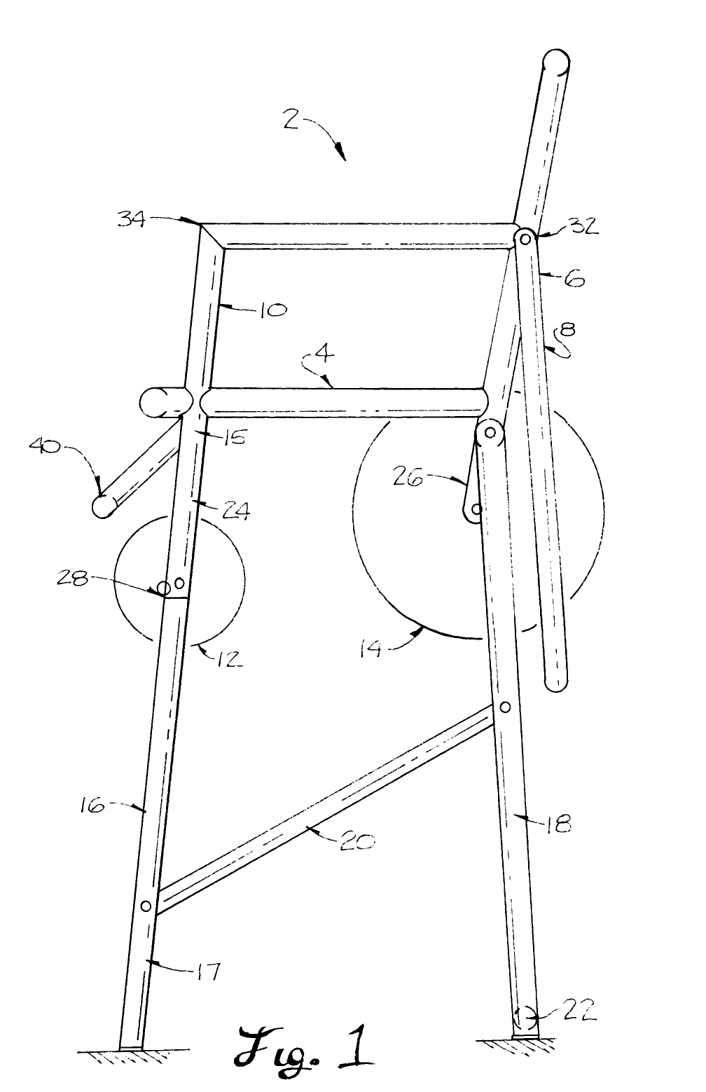

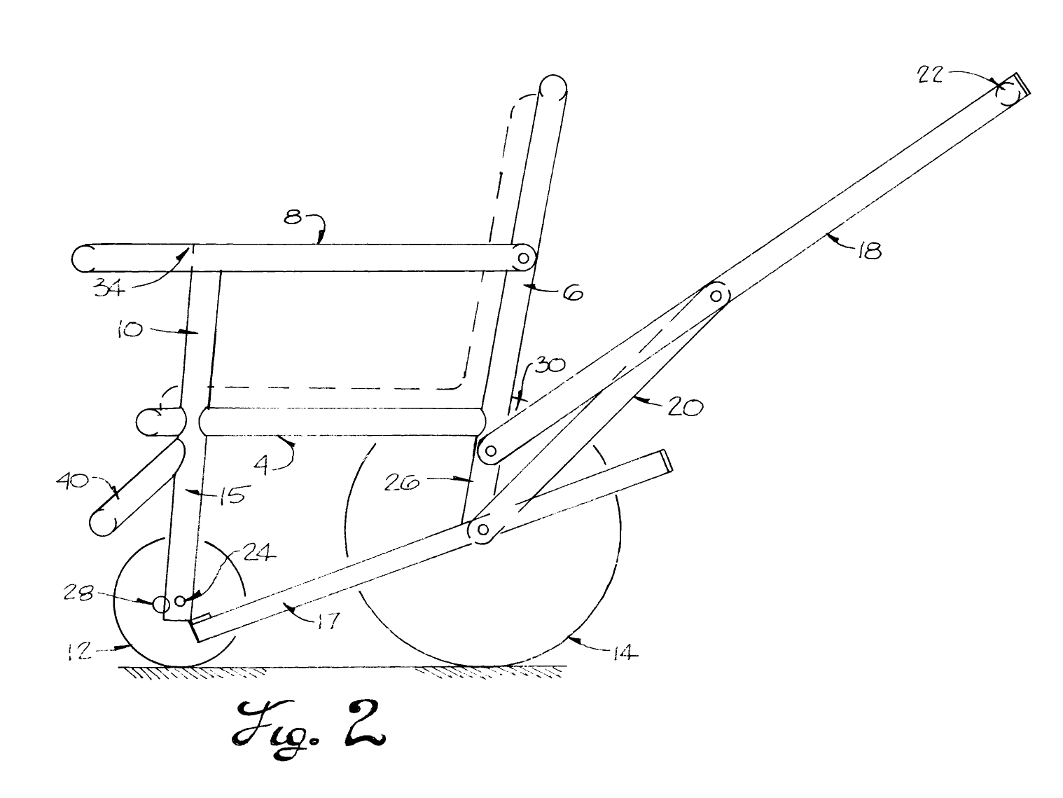

With reference to FIG. 1, a side view is shown of the convertible, multi-purpose children's chair device 2 of the present invention in a high chair configuration. With reference to FIG. 2, a side view is shown of the convertible, multi-purpose children's chair device 2 of the present invention in a stroller configuration.

In either a high chair or a stroller configuration, the device 2 comprises a chair, further comprising a seat 4 and a seat back 6; and a wheelbase, further comprising front wheels and back wheels. The device 2 further comprises a tray 8 that is pivotally connected by a tray pivot means 32 to the seat back 6. In an alternative embodiment of the device 2 of the present invention, the tray 8 may be detachable from the chair.

When the tray 8 is in a lowered position as shown in FIG. 1, it is supported by an arm rest 10 that is fixedly connected to the seat 4. To raise the tray 8, a tray release means 34 disengages the tray 8 from the arm rest 10.

When the tray 8 is in a disengaged, or raised, position, the device 2 may be used as a chair. When the tray 8 is in an engaged, or lowered, position, the tray 8 provides a usable surface, such as for use as a feeding tray or a play top. The tray 8 may also be disengaged to allow for ease of placement of a child or toy in or removal of a child or toy from the device 2.

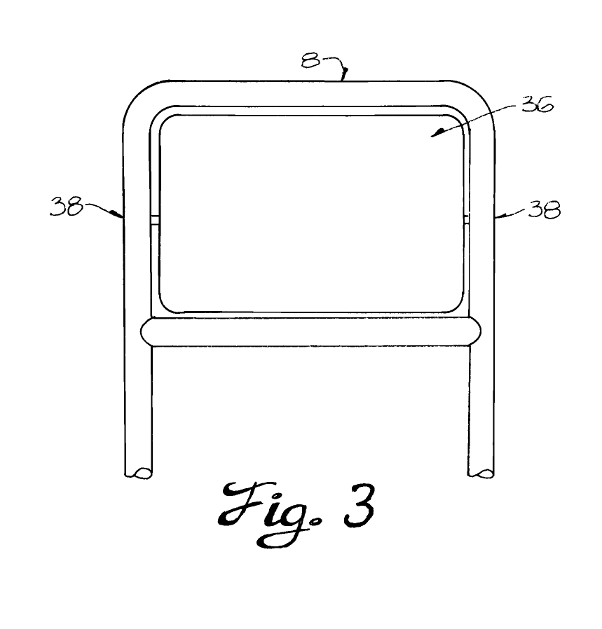

In an alternative embodiment of the present invention, as shown in FIG. 3, the tray 8 of the device 2 may have a tray insert 36. The tray insert 36 may rotatably communicate with the tray 8 by a tray insert rotation means 38. The tray insert rotation means 38 may be any suitable device, such as a pin and socket joint, which permits the tray insert 36 to be rotated, within the tray 8, between the two, opposed surfaces of the tray insert 36. The tray insert rotation means 38 may also permit the tray insert 36 to be removed from the tray 8 for cleaning, repair, replacement and the like. The tray insert rotation means 38 may also have a tray 8 fixation means to permit fixation of the tray insert 36 in a desired position to prevent involuntary rotation of the tray insert 36. The two opposed surfaces of the tray insert 36 may be any desired combination, such as a chalk board surface for play and a washable surface for feeding, or two different colored surfaces for aesthetic purposes.

In an alternative embodiment of the present invention, as shown in FIG. 1, an optional footrest 40 may be incorporated into the device 2 of the present invention. The footrest 40 may be fixedly attached or removably connected to the device 2. The footrest 40 may be collapsible and stowable on and/or within the device 2 itself when the footrest 40 is not in use. The footrest 40 in relation to the device 2 may be adjustable to a desired position for use.

When the device 2 is configured for use as a high chair as shown in FIG. 1, the front leg 16 and the back leg 18 are in an unarticulated position and a wheelbase, further comprising a front wheel 24 and a back wheel 26, is not in contact with the ground, but rather is retracted underneath the seat 4.

With reference to FIG. 2, the front leg 16 of the device 2 further comprises an unarticulable front leg portion 15 and an articulable front leg portion 17. When the device 2 is configured for use as a stroller as shown in FIG. 2, the articulable front leg portion 17 and the back leg 18 are in an articulated position;

wherein the wheelbase, further comprising the front wheel 24 and the back wheel 26, is in contact with the ground. Furthermore, when the back leg 18 is articulated in relation to the chair, preferably the seat back 6, of the device 2, the back leg 18 in conjunction with the stroller handle 22 provides a means by which the stroller may be manually propelled.

As shown in FIG. 1, at least one back leg brace 22 is fixedly attached to each of the back legs 18 of the device 2 of the present invention. The back leg brace provides stability to the device 2 when configured for use as a high chair. As shown in FIG. 2, the back leg brace 22 also functions as a stroller handle 22 of the device 2 when configured for use as a stroller. The back leg brace 22, or back leg braces, may be placed anywhere along the length of the back legs 18 such that a desired placement is achieved which provides for suitable stability and/or employment as a stroller handle 22.

In an alternative embodiment of the present invention, a back leg brace 22 is integral with each of the back legs 18 of the device 2. For instance, the back legs 18 and a back leg brace 22 may be a unitary U-shaped piece; wherein the base of the U-shaped piece serves as a back leg brace 22 and/or stroller handle 22.

To aid in the reconfiguration of the device 2 of the present invention from an unarticulated high chair configuration as shown in FIG. 1 to an articulated stroller configuration as shown in FIG. 2, a side brace 20 is employed. The side brace 20 is pivotally connected to the front leg 16, preferably on an inside surface of the front leg 16, and pivotally connected to the back leg 18, preferably on an outside surface of the back leg 18, such that the front leg 16 and the back leg 18 can move in relation to one another while the device 2 is being articulated, or reconfigured, for use as a stroller. The side brace 20 also imparts additional stability to the device 2 when configured for use as a high chair. As shown in FIG. 2, the side brace 20 has been repositioned as a result of the reconfiguration of the device 2 for use as a stroller.

Because the side brace 20 movably communicates with both a back leg 18 and an articulable front leg portion 17, the side brace 20 allows for simultaneous articulation of the back leg 18 and the articulable front leg portion 17 when reconfiguring the device 2 from a high chair configuration to a stroller configuration and vice versa. The device 2 may also use any optional, suitable device 2 fixation means, such as a latch, to permit fixation of the device 2 in a desired configuration and to prevent involuntary reconfiguration, or articulation, of the device 2, back and forth between the high chair and stroller configurations.

As shown in FIG. 1, preferably the front wheel mount 24 is pivotably connected to an inside surface of an unarticulable front leg portion 15. Such an inside surface mounting position allows for the device 2 to be configured without interference from the front wheel mount 24.

As shown in FIG. 1, preferably the back wheel mount 26 is pivotably connected to an inside surface of a back leg 18 and is pivotably connected to, preferably, an outside surface of the seat 4 or any other suitable location on the chair. Such a mounting position allows for the device 2 to be configured without interference from the back wheel mount 26. Additionally, such a mounting position allows for the back wheels 14 to be positioned for engagement with the ground simultaneously with reconfiguration of the device 2 from a high chair configuration to a stroller configuration. Likewise, such a mounting position allows for the back wheels 14 to be positioned for stowage under the seat 4 simultaneously with reconfiguration of the device 2 from a high chair configuration to a stroller configuration.

To reconfigure the device 2 from a high chair configuration to a stroller configuration, a user, if applicable, releases the optional device 2 fixation means; grips the back leg brace 22; and moves the back legs 18 in an upwardly direction about the back articulation means 30. Once the device 2 has been maneuvered into the stroller configuration, the user, if applicable, reengages the optional device 2 fixation means.

To reconfigure the device 2 from a stroller chair configuration to a high chair configuration, a user, if applicable, releases the optional device 2 fixation means; grips the stroller handle 22; and moves the back legs 18 in a downwardly direction about the back articulation means 30. Once the device 2 has been maneuvered into the high chair configuration, the user, if applicable, reengages the optional device 2 fixation means.

In either of the configuration operations of the device 2, maneuvering of the back legs 18 by a user effects simultaneous maneuvering of the front legs 16, the front wheels 12 and the back wheels 14 into each of their applicable positions for the applicable configuration of the device 2. Accordingly, a user may maneuver the device 2 between the high chair and stroller configurations in one operation.

Although the present invention has been described with reference to specific embodiments, modifications and variations of the present invention are possible without departing from the scope of the invention, which is defined by the claims set forth below.

The invention claimed is:

1. A convertible, multi-purpose children's chair comprising:
a. A chair which is inter-related with;
b. A wheelbase;
c. Front legs, comprising an articulable front leg portion and an unarticulable front leg portion; wherein said articulable front leg portion and said unarticulable front leg portion are articulable in relation to each other; further wherein said front legs are inter-related with said chair; and
d. Back legs which are inter-related to said chair; wherein said back legs are articulably related with said chair.

2. The convertible, multi-purpose children's chair of claim 1, further comprising a tray which is inter-related with said chair.

3. The convertible, multi-purpose children's chair of claim 2, further comprising a tray insert within said tray.

4. The convertible, multi-purpose children's chair of claim 3, further wherein said tray insert is rotatable within said tray.

5. A convertible, multi-purpose children's chair comprising:
a. A chair which is inter-related with;
b. A wheelbase;
c. Front legs, comprising an articulable front leg portion and an unarticulable front leg portion; wherein said articulable front leg portion and said unarticulable front leg portion are articulable in relation to each other; further wherein said front legs are inter-related with said chair;
d. Back legs which are inter-related to said chair; wherein said back legs are articulably related with said chair; and
e. A tray which is inter-related with said chair.

6. The convertible, multi-purpose children's chair of claim 5, further comprising a tray insert within said tray.

7. The convertible, multi-purpose children's chair of claim 6, further wherein said tray insert is rotatable within said tray.

8. A convertible, multi-purpose children's chair comprising:
a. A chair comprising a seat and a seat back;
b. Front legs inter-related with said seat, comprising an articulable front leg portion and an unarticulable front leg portion; wherein said articulable front leg portion and said unarticulable front leg portion are articulable in relation to each other;
c. Back legs which are inter-related to said seat; wherein said back legs are articulably related with said seat back;
d. A wheelbase comprising front wheels and back wheels; wherein said front wheels are inter-related with said front legs and said back wheels are inter-related with said seat and said back legs; and
e. A tray which is inter-related with said seat back; wherein said tray is pivotably connected with said seat back.

9. The convertible, multi-purpose children's chair of claim 8, further comprising a tray insert within said tray.

10. The convertible, multi-purpose children's chair of claim 9, further wherein said tray insert is rotatable within said tray.
